(19) United States
(12) Patent Application Publication
(10) Pub. No.: US 2019/0265116 A1
(43) Pub. Date: Aug. 29, 2019

(54) TORQUE DETECTION DEVICE

(71) Applicant: AISIN AW CO., LTD., Anjo-shi, Aichi-ken (JP)

(72) Inventors: Kazumichi TSUKUDA, Okazaki (JP); Hiroyuki OGASAWARA, Anjo (JP); Masashi OKUMURA, Okazaki (JP)

(73) Assignee: AISIN AW CO., LTD., Anjo-shi, Aichi-ken (JP)

(21) Appl. No.: 16/341,660

(22) PCT Filed: Dec. 12, 2017
(86) PCT No.: PCT/JP2017/044559

§ 371 Date: Apr. 12, 2019

(30) Foreign Application Priority Data
Dec. 27, 2016 (JP) 2016-253604

(51) Int. Cl. G01L 3/10; F16H 57/00; F16H 9/18

(52) U.S. Cl. CPC G01L 3/101; F16H 9/18; F16H 57/0025

(57) ABSTRACT

A torque detection device in a power transmission device including a speed change mechanism, the torque detection device detecting torque on a rotary shaft that rotates with a gear, the torque detection device including: a first encoder having a first detected portion and directly fixed to the rotary shaft so as to rotate with the rotary shaft; a second encoder having a second detected portion and directly fixed to the gear so that the second encoder rotates with the gear and that the second detected portion is located near the first detected portion; and a rotational displacement detection sensor that detects rotational displacements of the first detected portion and the second detected portion.

### BACKGROUND

The present disclosure relates to torque detection devices.

Conventionally, a torque detection device in which an inner shaft is disposed inside a torque transmission shaft of a speed change mechanism of a power transmission device, one end of the torque transmission shaft is connected to one end of the inner shaft so that the torque transmission shaft and the inner shaft are not rotatable relative to each other, a first encoder having a first detected portion is mounted on the other end of the torque transmission shaft, a second encoder having a second detected portion is mounted on the other end of the inner shaft, and first and second detecting portions of first and second sensors are disposed near the first and second detected portions so as to face the first and second detected portions has been proposed as this type of torque detection devices (see, e.g., JP 2015-172563 A). This torque detection device detects torque on the torque transmission shaft based on the phase difference ratio between output signals of the first and second sensors in accordance with elastic torsional deformation of both ends of the torque transmission shaft (relative displacement between the first and second encoders) which is caused when the torque is transmitted by the torque transmission shaft. In this torque transmission device, the first and second encoders are mounted on the other ends of the torque transmission shaft and the inner shaft, whereby satisfactory mountability of the sensors can be implemented and harness wiring work can be simplified.

### SUMMARY

In the above torque detection device, however, a separate member for detecting torque, such as disposing an inner shaft inside a torque transmission shaft, is required in order to detect torsion at two positions on the torque transmission shaft which are separated from each other with a single sensor and first and second encoders.

An exemplary aspect of the disclosure provides a configuration in which no separate member for detecting torque is required for a torque detection device that detects torque on a rotary shaft by a single sensor and first and second encoders.

The torque detection device of the present disclosure has taken the following measures in order to achieve the exemplary aspect.

The torque detection device of the present disclosure is a torque detection device in a power transmission device including a speed change mechanism. The torque detection device detects torque on a rotary shaft that rotates with a gear, and the torque detection device includes: a first encoder having a first detected portion and directly fixed to the rotary shaft so as to rotate with the rotary shaft; a second encoder having a second detected portion and directly fixed to the gear so that the second encoder rotates with the gear and that the second detected portion is located near the first detected portion; and a rotational displacement detection sensor that detects rotational displacements of the first detected portion and the second detected portion.

The torque detection device of the present disclosure includes: the first encoder having the first detected portion and directly fixed to the rotary shaft so as to rotate with the rotary shaft; the second encoder having the second detected portion and directly fixed to the gear so that the second encoder rotates with the gear and that the second detected portion is located near the first detected portion; and the rotational displacement detection sensor that detects rotational displacements of the first detected portion and the second detected portion. No separate member for detecting torque is thus required for the torque detection device that detects torque on the rotary shaft by the single rotational displacement detection sensor and the first and second encoders. Specifically, no separate member is required between the rotary shaft and the first encoder and between the gear and the second encoder. This can restrain an increase in size of the torque detection device and thus the power transmission device.

### BRIEF DESCRIPTION OF THE DRAWINGS

FIG. 1 is a configuration diagram schematically showing the configuration of a power transmission device.

FIG. 2 is an enlarged view of a main part of the power transmission device.

FIG. 3 is an enlarged view of a portion around a torque detection device.

### DETAILED DESCRIPTION OF EMBODIMENTS

A mode for carrying out the disclosure of the present disclosure will be described with reference to the accompanying drawings.

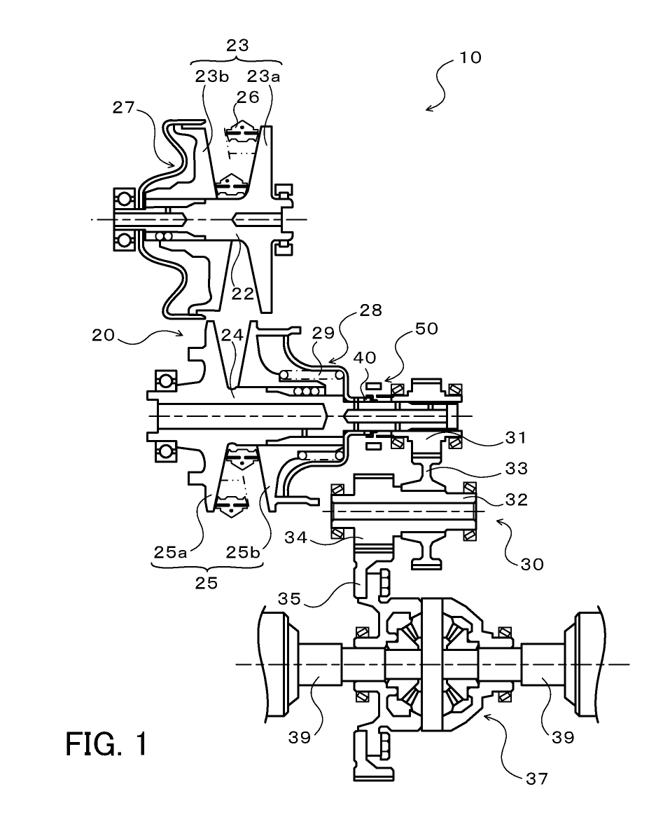

FIG. 1 is a configuration diagram schematically showing the configuration of a power transmission device 10. The power transmission device 10 is configured as a device that transmits power from a power source such as an engine to drive shafts 39 connected to drive wheels. The power transmission device 10 includes a stepless speed change mechanism 20, a gear mechanism 30, and a differential gear (operation mechanism) 37.

The stepless speed change mechanism 20 includes: a primary shaft (first shaft) 22 serving as a drive-side rotary shaft; a primary pulley 23 mounted on the primary shaft 22; a secondary shaft (second shaft) 24 disposed parallel to the primary shaft 22 and serving as a driven-side rotary shaft; a secondary pulley 25 mounted on the secondary shaft 24; a transmission belt 26 wound around a groove of the primary pulley 23 and a groove of the secondary pulley 25; a primary cylinder 27 serving as a hydraulic actuator for changing the groove width of the primary pulley 27; and a secondary cylinder 28 serving as a hydraulic actuator for changing the groove width of the secondary pulley 25.

The primary shaft 22 is connected via a forward-reverse switching mechanism (not shown) to an input shaft (not shown) connected to a power source (not shown) such as an engine. The primary pulley 23 has a fixed sheave 23a formed integrally with the primary shaft 22 and a movable sheave 23b supported by the primary shaft 22 via a ball spline so that the movable sheave 23b can slide in the axial direction. The secondary pulley 25 has a fixed sheave 25a formed integrally with the secondary shaft 24 and a movable sheave 25b supported by the secondary shaft 24 via a ball spline so that the movable sheave 25b can slide in the axial direction and is biased in the axial direction by a return spring 29.

The primary cylinder 27 is formed behind the movable sheave 23b of the primary pulley 23 and the secondary cylinder 28 is formed behind the movable sheave 25b of the secondary pulley 25. Hydraulic oil is supplied from a hydraulic control device to the primary cylinder 27 and the secondary cylinder 28 in order to change the groove widths of the primary pulley 23 and the secondary pulley 25. Power transmitted from the power source to the primary shaft 22 via the input shaft and the forward-reverse switching mechanism can thus be steplessly shifted and transmitted to the secondary shaft 24. The power thus transmitted to the secondary shaft 24 is transmitted to right and left drive wheels via the gear mechanism 30, the differential gear 37, and the drive shafts 39.

The gear mechanism 30 has: a counter drive gear 31 that rotates with the secondary shaft 24; a counter shaft (third shaft) 32 extending parallel to the secondary shaft 24 and the drive shafts 39 and rotatably supported by a transmission case 12 via a bearing; a counter driven gear 33 fixed to the counter shaft 32 and meshing with the counter drive gear 31; a drive pinion gear (final drive gear) 34 molded integrally with the counter shaft 32 or fixed to the counter shaft 32; and a differential ring gear (final driven gear) 35 meshing with the drive pinion gear 34 and connected to the differential gear 37.

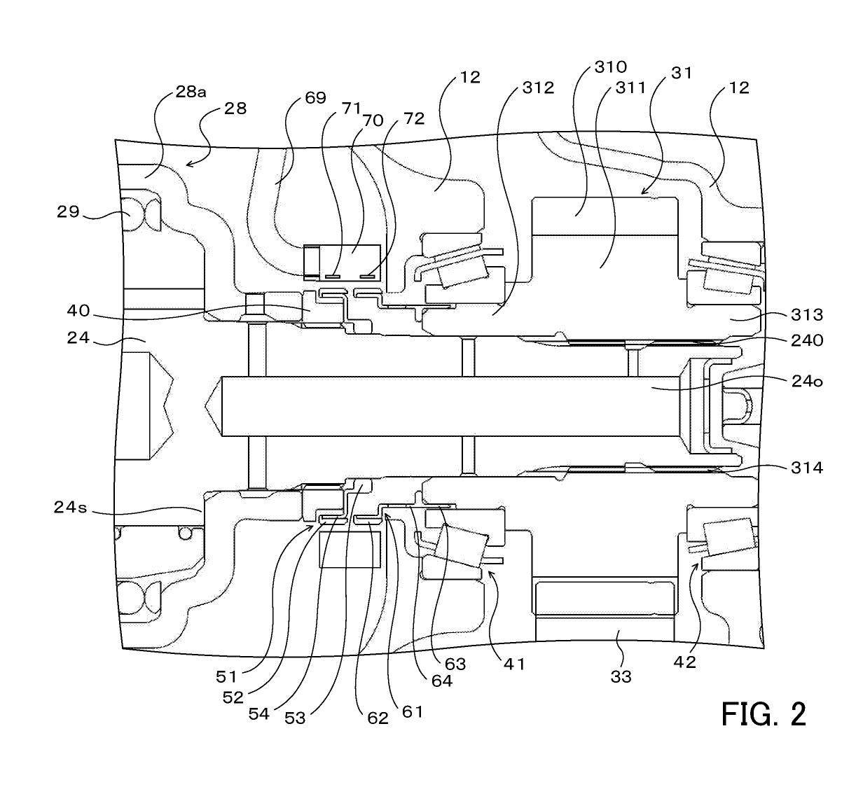

FIG. 2 is an enlarged view of a main part of the power transmission device 10. As shown in the figure, the secondary shaft 24 has an oil passage 24o formed therein through which hydraulic oil is supplied to each part in the transmission case 12 such as, e.g., the counter drive gear 31 and bearings 41, 42. A cylinder member 28a that forms the secondary cylinder 28 is fixed to the secondary shaft 24 by a stepped portion 24s of the secondary shaft 24 and a nut 40 serving as a fixing member.

The counter drive gear 31 has a hollow tubular shape and includes a large-diameter tubular portion 311 having a plurality of external teeth 310 meshing with respective gear teeth of the counter driven gear 33 and small-diameter tubular portions 312, 313 extended from the large-diameter tubular portion 311 toward the secondary pulley 25 and the opposite side in the axial direction and having a smaller diameter than the large-diameter tubular portion 311. The large-diameter tubular portion 311 and the small-diameter tubular portion 313 have fitting splines 314 formed in their inner peripheral surfaces. The fitting splines 314 are fitted in splines 240 formed in the outer peripheral surface of the opposite end of the secondary shaft 24 from the secondary pulley 25. That is, the fitting splines 314 and the splines 240 function as a fitting portion. The counter drive gear 31 thus rotates with the secondary shaft 24. Of the counter drive gear 31, the large-diameter tubular portion 311 and the small-diameter tubular portion 313 which have the fitting splines 314 in their inner peripheral surfaces contribute to torque transmission, whereas the small-diameter tubular portion 312 that does not have the fitting splines 314 in its inner peripheral surface does not contribute to torque transmission. The small-diameter tubular portions 312, 313 of the counter drive gear 31 are rotatably supported by the transmission case 12 via the bearings 41, 42.

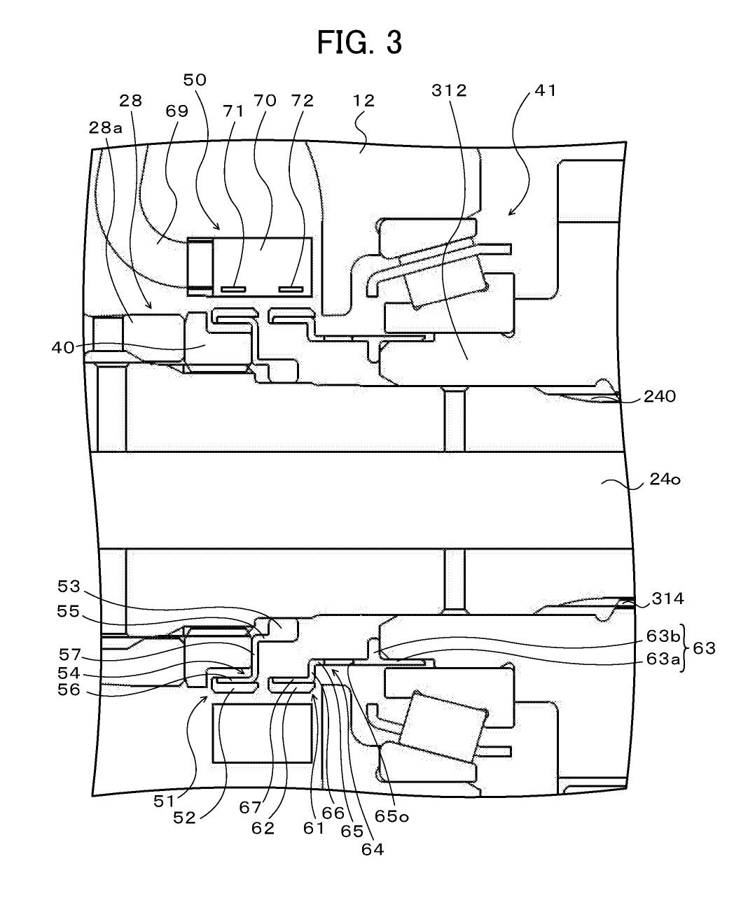

In the power transmission device 10 thus configured, a torque detection device 50 detects torque on the secondary shaft 24. FIG. 3 is an enlarged view of a portion around the torque detection device 50. As shown in FIGS. 2 and 3, the torque detection device 50 includes: a first encoder 51 directly fixed (fixed with no other members therebetween) to the secondary shaft 24 so as to rotate with the secondary shaft 24; a second encoder 61 directly fixed (fixed with no other members therebetween) to the counter drive gear 31 so as to rotate with the counter drive gear 31; and a rotational displacement detection sensor 70 that detects rotational displacements of the first and second encoders 51, 61.

The first encoder 51 includes an annular first detected portion 52, a first fixed portion 53 directly fixed to the outer peripheral surface of the secondary shaft 24, and a first extended portion 54 extended from the first fixed portion 53 and having the first detected portion 52 fixed thereto. The first detected portion 52 has N-poles and S-poles (e.g., 25 pole pairs) alternately arranged at equal pitches on its outer peripheral surface in the circumferential direction, and alternately change magnetic characteristics at equal pitches in the circumferential direction. The first detected portion 52 is fixed to the first extended portion 54 so as to overlap at least a part of the nut 40 in the axial direction as viewed in the radial direction of the first detected portion 52. The first fixed portion 53 has a tubular shape and is press-fitted on the secondary shaft 24 between the nut 40 and the counter drive gear 31 in the axial direction of the secondary shaft 24. The first extended portion 54 has: a tubular small-diameter tubular portion 55 extended from a secondary cylinder 28-side end (the left end in FIG. 3) of the first fixed portion 53 toward the secondary cylinder 28 (to the left in FIG. 3); an annular portion 56 having an annular shape and extended radially outward from a free end (the left end in FIG. 3) of the small-diameter tubular portion 55; and a large-diameter tubular portion 57 having a tubular shape, extended from the outer periphery of the annular portion 56 toward the secondary cylinder 28 (to the left in FIG. 3), and having the first detected portion 52 fixed to its outer peripheral surface. In the first encoder 51, the first detected portion 52 is positioned as the annular portion 56 contacts an end face of the nut 40 when the first fixed portion 53 is press-fitted on the secondary shaft 24.

The second encoder 61 includes an annular second detected portion 62, a second fixed portion 63 directly fixed to the outer peripheral surface of the small-diameter tubular portion 312 (the portion that does not contribute to torque transmission) of the counter drive gear 31, and a second extended portion 64 extended from the second fixed portion 63 toward the secondary cylinder 28 (toward the first encoder 51) and having the second detected portion 62 fixed thereto. The second detected portion 62 is configured in the same manner as that of the first detected portion 52. The second detected portion 62 is fixed to the second extended portion 64 so as to overlap at least a part of the first fixed portion 53 in the axial direction as viewed in the radial direction of the second detected portion 62 and to be located near the first detected portion 52 (e.g., at an interval of about several millimeters in the axial direction). The second fixed portion 63 has a tubular portion 63a having a tubular shape and an annular portion 63b having an annular shape and extended radially inward from a free end (the left end in FIG. 3) of the tubular portion 63a. The tubular portion 63a of the second fixed portion 63 is press-fitted on a secondary cylinder 28-side end of the small-diameter tubular portion 312 of the counter drive gear 31, and at that time, the annular portion 63b contacts an end face of the small-diameter tubular portion 312. At this time, the second fixed portion 63 overlaps the bearing 41 in the axial direction as viewed in the radial direction of the second fixed portion 63. The second extended portion 64 has: a small-diameter tubular portion 65 having a tubular shape and extended from an annular portion 63b-side end (the left end in FIG. 3) of the tubular portion 63a of the second fixed portion 63 toward the secondary cylinder 28 (to the left in FIG. 3); an annular portion 66 having an annular shape and extended radially outward from a free end (the left end in FIG. 3) of the small-diameter tubular portion 65; and a large-diameter tubular portion 67 having a tubular shape, extended from the outer periphery of the annular portion 66 toward the secondary cylinder 28 (to the left in FIG. 3), and having the second detected portion 62 fixed to its outer peripheral surface. The small-diameter tubular portion 65 has an oil hole 65o. Hydraulic oil from the secondary shaft 24 side can thus be supplied to the bearing 41 through the oil hole 65o. In the second encoder 61, the second detected portion 62 is positioned with respect to the counter drive gear 31 as the annular portion 63b contacts the end face of the small-diameter tubular portion 312 when the tubular portion 63a is press-fitted on the end of the small-diameter tubular portion 312. The second detected portion 62 is positioned with respect to the first detected portion 52 when the counter drive gear 31 is positioned with respect to the secondary shaft 24.

The rotational displacement detection sensor 70 is fixed to the transmission case and includes first and second detecting portions 71, 72. The first and second detecting portions 71, 72 have a magnetic detecting element, such as a Hall element, a Hall IC, or an MR element, and are placed near the first and second detected portions 52, 62 of the first and second encoders 51, 61 so as to face the first and second detected portions 52, 62. The first and second detecting portions 71, 72 change their output signals in accordance with a change in magnetic characteristics of the first and second detected portions 52, 62. The first and second detecting portions 71, 72 transmit the output signals to a torque calculation device (not shown) via a cable 69, and the torque calculation device calculates torque on the secondary shaft 24 in accordance with the output signals from the first and second detected portions 52, 62. The secondary shaft 24 is subjected to torsion when it transmits torque. The larger the torque on the secondary shaft 24 is, the larger the extent of torsion of the secondary shaft 24 is. The torque on the secondary shaft 24 can be therefore detected (estimated) if the extent of torsion at the position on the secondary shaft 24 where the first fixed portion 53 is fixed and the extent of torsion at the position on the counter drive gear 31 where the second fixed portion 63 is fixed (the position of the fitted portion between the secondary shaft 24 and the counter drive gear 31) can be obtained. In the present embodiment, the torque calculation device detects torque on the secondary shaft 24 by converting the phase difference between the rises or falls of square wave output signals from the first and second detected portions 52, 62 to torque on the secondary shaft 24. The torque on the secondary shaft 24 thus detected is used for hydraulic control that is performed to change the groove widths of the primary pulley 23 and the secondary pulley 25 of the stepless speed change mechanism 20 etc.

In the torque detection device 50 of the present disclosure, the first encoder 51 is directly fixed to the secondary shaft 24 between the nut 40 and the counter drive gear 31 in the axial direction of the secondary shaft 24, and the second encoder 61 is directly fixed to the secondary shaft 24-side end of the small-diameter tubular portion 312 (the portion that does not contribute to torque transmission) of the counter drive gear 31. With this configuration, in the torque detection device 50 including the first encoder 51, the second encoder 61, and the rotational displacement detection sensor 70, the first encoder 51 and the second encoder 61 can be separated from each other on a torque transmission path. Accordingly, torsion of the secondary shaft 24 can be detected and torque on the secondary shaft 24 can be detected. No separate member for detecting torque on the secondary shaft 24 is therefore required, whereby an increase in size of the torque detection device 50 and thus the power transmission device 10 can be restrained. Configuring the torque detection device 50 in this manner allows the oil passage 24o to be formed in the secondary shaft 24.

Moreover, the first detected portion 52 of the first encoder 51 overlaps at least a part of the nut 40 in the axial direction as viewed in the radial direction of the first detected portion 52, and the second detected portion 62 of the second encoder 61 overlaps the first fixed portion 53 of the first encoder 51 in the axial direction as viewed in the radial direction of the second detected portion 62. This can restrain an increase in axial length of the secondary shaft 24 which is caused by disposing the torque detection device 50. In addition, the second fixed portion 63 overlaps the bearing 41 in the axial direction as viewed in the radial direction of the second fixed portion 63. This can further restrain an increase in axial length of the secondary shaft 24.

The torque on the secondary shaft 24 thus detected is used for hydraulic control that is performed to change the groove widths of the primary pulley 23 and the secondary pulley 25 of the stepless speed change mechanism 20 etc. This can reduce the holding pressure for the transmission belt 26 within the extent that the transmission belt 26 does not slip, as compared to configurations that do not detect torque on the secondary shaft 24. That is, it is not necessary to set the holding pressure for the transmission belt 26 with a relatively large margin so that the transmission belt 26 does not slip even if output torque changes rapidly as in conventional examples. The holding pressure can thus be reduced as compared to the conventional examples.

In the above torque detection device 50, the first detected portion 52 of the first encoder 51 overlaps at least a part of the nut 40 in the axial direction as viewed in the radial direction of the first detected portion 52, and the second detected portion 62 of the second encoder 61 overlaps the first fixed portion 53 of the first encoder 51 in the axial direction as viewed in the radial direction of the second detected portion 62. However, the present disclosure is not limited to this. The first detected portion 52 may not overlap the nut 40 in the axial direction as viewed in the radial direction of the first detected portion 52, and the second detected portion 62 may not overlap the first fixed portion 53 of the first encoder 51 in the axial direction as viewed in the radial direction of the second detected portion 62.

In the above torque detection device 50, the first encoder 51 is fixed to the secondary shaft 24 between the nut 40 and the counter drive gear 31, and the second encoder 61 is fixed to the small-diameter tubular portion 312 of the counter drive gear 31. However, the present disclosure is not limited to this. The first encoder 51 may be fixed to the secondary shaft 24 on the opposite side of the counter drive gear 31 from the secondary pulley 25 and the second encoder 61 may be fixed to the small-diameter tubular portion 313 of the counter drive gear 31.

The above torque detection device 50 is configured as a magnetic device including the first encoder 51, the second encoder 61, and the rotational displacement detection sensor 70. However, the torque detection device 50 may be configured as, e.g., an optical device as long as it can detect the difference in rotational speed or the difference in rotational phase.

The above torque detection device 50 detects torque on the secondary shaft (second shaft) 24 of the stepless speed change mechanism 20. However, the present disclosure is not limited to this. The torque detection device 50 may detect torque on the counter shaft (third shaft) 52 or may detect torque on the primary shaft (first shaft) 22.

The above power transmission device 10 includes the stepless speed change mechanism 20 as a speed change mechanism. However, the present disclosure is not limited to this. The power transmission device 10 may include a stepped speed change mechanism.

As described above, the torque detection device of the present disclosure is a torque detection device (50) in a power transmission device (10) including a speed change mechanism (20). The torque detection device (50) which detects torque on a rotary shaft (24) that rotates with a gear (31), and includes: a first encoder (51) having a first detected portion (52) and directly fixed to the rotary shaft (24) so as to rotate with the rotary shaft (24); a second encoder (61) having a second detected portion (62) and directly fixed to the gear (31) so that the second encoder (61) rotates with the gear (31) and that the second detected portion is located near the first detected portion; and a rotational displacement detection sensor (70) that detects rotational displacements of the first detected portion (52) and the second detected portion (62).

The torque detection device of the present disclosure includes: the first encoder having the first detected portion and directly fixed to the rotary shaft so as to rotate with the rotary shaft; the second encoder having the second detected portion and directly fixed to the gear so that the second encoder rotates with the gear and that the second detected portion is located near the first detected portion; and the rotational displacement detection sensor that detects rotational displacements of the first detected portion and the second detected portion. No separate member for detecting torque is thus required for the torque detection device that detects torque on the rotary shaft by the single rotational displacement detection sensor and the first and second encoders. Specifically, no separate member is required between the rotary shaft and the first encoder and between the gear and the second encoder. This can restrain an increase in size of the torque detection device and thus the power transmission device.

In this torque detection device of the present disclosure, splines (240, 314) may be formed in an outer peripheral surface of the rotary shaft (24) and an inner peripheral surface of the gear (31) at positions separated from the first encoder (51) in an axial direction of the power transmission device (10) and the splines (240) of the rotary shaft (24) and the splines (314) of the gear (31) may be fitted together, the gear (31) may have, between the splines (314) and the first encoder (51) in the axial direction, a non-contributing portion (312) that does not contribute to torque transmission, and the second encoder (61) may be directly fixed to the non-contributing portion (312) of the gear (31). The first encoder directly fixed to the rotary shaft and the second encoder directly fixed to the gear can thus be separated from each other on a torque transmission path. Accordingly, torsion of the rotary shaft can be detected and torque on the rotary shaft can be detected by the single rotational displacement sensor and the first and second encoders. No separate member is therefore required, whereby an increase in size of the torque detection device and thus the power transmission device can be restrained. In this case, the non-contributing portion (312) may be rotatably supported by a case (12) via a bearing (41).

In the torque detection device of the present disclosure, the speed change mechanism (20) may be a stepless speed change mechanism having a primary shaft (22) having a primary pulley (23), a secondary shaft (24) having a secondary pulley (25), and a transmission belt (26) wound around the primary pulley (23) and the secondary pulley (25), the gear (31) may be connected to an opposite end of the secondary shaft (24) from the secondary pulley (25), the rotary shaft may be the secondary shaft (24), the first encoder (51) may be directly fixed to the secondary shaft (24) between the secondary pulley (25) and the gear (31) in an axial direction of the secondary shaft (24), and the second encoder (61) may be directly fixed to the gear (31) on the secondary pulley (25) side of the gear (31) in the axial direction. With this configuration, a holding pressure for the transmission belt can be optimally set in accordance with actual torque detected by the torque detection device. The holding pressure for the transmission belt can thus be reduced within the extent that the transmission belt does not slip. That is, it is not necessary to set the holding pressure for the transmission belt with a relatively large margin so that the transmission belt does not slip even if output torque changes rapidly as in conventional examples. The holding pressure can thus be reduced as compared to the conventional examples.

In this case, the stepless speed change mechanism (20) may further have a secondary cylinder (28) for changing a groove width of the secondary pulley (25) and a fixing member (40) for fixing a cylinder member (28a) that forms the secondary cylinder (28) to the secondary shaft (24), the first encoder (51) may have a first fixed portion (53) directly fixed to the secondary shaft (24) between the fixing member (40) and the gear (31) in the axial direction and a first extended portion (54) which is extended from the first fixed portion (53) toward the fixing member (40) and to which the first detected portion (52) is fixed so that the first detected portion (52) overlaps at least a part of the fixing member (40) in the axial direction as viewed in a radial direction of the first detected portion (52), and the second encoder (61) may have a second fixed portion (63) directly fixed to the gear (31) and a second extended portion (64) which is extended from the second fixed portion (63) toward the first encoder (51) and to which the second detected portion (62) is fixed so that the second detected portion (62) overlaps at least a part of the first fixed portion (53) in the axial direction as viewed in a radial direction of the second detected portion (62). This configuration can restrain an increase in axial length of the secondary shaft which is caused by disposing the torque detection device.

In this case, the gear (35) may be rotatably supported by a case (12) via a bearing (41), and the second fixed portion (63) may overlap at least a part of the bearing (41) in the axial direction as viewed in a radial direction of the second fixed portion (63). This configuration can further restrain an increase in axial length of the secondary shaft.

Although the mode for carrying out the present disclosure is described above, it should be understood that the present disclosure is not limited in any way to the embodiment and may be carried out in various forms without departing from the spirit and scope of the present disclosure.

### INDUSTRIAL APPLICABILITY

The present disclosure can be used in the manufacturing industry of torque detection devices etc.

1. A torque detection device in a power transmission device including a speed change mechanism, the torque detection device detecting torque on a rotary shaft that rotates with a gear, the torque detection device comprising:
a first encoder having a first detected portion and directly fixed to the rotary shaft so as to rotate with the rotary shaft;
a second encoder having a second detected portion and directly fixed to the gear so that the second encoder rotates with the gear and that the second detected portion is located near the first detected portion; and
a rotational displacement detection sensor that detects rotational displacements of the first detected portion and the second detected portion.

2. The torque detection device according to claim 1, wherein
splines are formed in an outer peripheral surface of the rotary shaft and an inner peripheral surface of the gear at positions separated from the first encoder in an axial direction of the power transmission device, and the splines of the rotary shaft and the splines of the gear are fitted together,
the gear has, between the splines and the first encoder in the axial direction, a non-contributing portion that does not contribute to torque transmission, and
the second encoder is directly fixed to the non-contributing portion of the gear.

3. The torque detection device according to claim 2, wherein
the non-contributing portion is rotatably supported by a case via a bearing.

4. The torque detection device according to claim 1, wherein
the speed change mechanism is a stepless speed change mechanism having a primary shaft having a primary pulley, a secondary shaft having a secondary pulley, and a transmission belt wound around the primary pulley and the secondary pulley,
the gear is connected to an opposite end of the secondary shaft from the secondary pulley,
the rotary shaft is the secondary shaft,
the first encoder is directly fixed to the secondary shaft between the secondary pulley and the gear in an axial direction of the secondary shaft, and
the second encoder is directly fixed to the gear on the secondary pulley side of the gear in the axial direction.

5. The torque detection device according to claim 4, wherein
the stepless speed change mechanism further has a secondary cylinder for changing a groove width of the secondary pulley and a fixing member for fixing a cylinder member that forms the secondary cylinder to the secondary shaft,
the first encoder has a first fixed portion directly fixed to the secondary shaft between the fixing member and the gear in the axial direction and a first extended portion which is extended from the first fixed portion toward the fixing member and to which the first detected portion is fixed so that the first detected portion overlaps at least a part of the fixing member in the axial direction as viewed in a radial direction of the first detected portion, and
the second encoder has a second fixed portion directly fixed to the gear and a second extended portion which is extended from the second fixed portion toward the first encoder and to which the second detected portion is fixed so that the second detected portion overlaps at least a part of the first fixed portion in the axial direction as viewed in a radial direction of the second detected portion.

6. The torque detection device according to claim 5, wherein
the gear is rotatably supported by a case via a bearing, and
the second fixed portion overlaps at least a part of the bearing in the axial direction as viewed in a radial direction of the second fixed portion.
